(19) United States
(12) Patent Application Publication
(10) Pub. No.: US 2025/0292608 A1
(43) Pub. Date: Sep. 18, 2025

(54) OBJECT DETECTION IN DOCUMENTS USING NEURAL NETWORKS

(71) Applicant: ABBYY Development Inc., Dover, DE (US)

(72) Inventors: Ivan Zagaynov, Dolgoprudniy (RU); Marat Khabibullin, Kazan (RU); Stanislav Semenov, Moscow (RU)

(21) Appl. No.: 18/602,631

(22) Filed: Mar. 12, 2024

(51) Int. Cl. G06V 30/413; G06V 10/26; G06V 10/82; G06V 30/14; G06V 30/166; G06V 30/19; G06V 30/416

(52) U.S. Cl. CPC G06V 30/413; G06V 10/26; G06V 10/82; G06V 30/141; G06V 30/166; G06V 30/19127; G06V 30/1918; G06V 30/416

(57) ABSTRACT

Aspects and implementations provide for techniques of fast and efficient identification of objects of multiple types in electronic documents. The disclosed techniques include, for example, processing, using a machine learning model (MLM), an image of a document to generate a plurality of pixel-level maps (PLMs), characterizing associations of pixels of the image with various object types. The MLM includes a backbone neural network (NN) processing the image and generating a feature tensor for the image. The MLM further includes a plurality of classification NNs that process the feature tensor and generate PLMs. The techniques further include generating, using the PLMs, an object-level map identifying placement of one or more objects in the document. The classification NNs may be trained together (end-to-end) with the backbone NN.

### TECHNICAL FIELD

The implementations of the disclosure relate generally to computer systems and, more specifically, to systems and methods for extracting textual information contained in documents.

### BACKGROUND

Detection and recognition of textual and non-textual content of electronic documents is an important task in processing, storing, and referencing documents. Documents can be obtained using a variety of techniques including scanning, photographing, digital synthesis, and/or the like. Optical character recognition (OCR) identifies texts (characters, words, phrases, etc.) from rasterized (pixelated) depictions of symbols by identifying reference symbols that most closely resemble symbols depicted in the documents and form words, sentences, and other units of texts of documents. Object recognition identifies non-textual objects, such as images, elements of graphics, logos, stamps, and other document content.

### SUMMARY OF THE DISCLOSURE

Implementations of the present disclosure are directed to fast and efficient techniques for identification of textual and non-textual document content using machine learning models.

In one implementation, a method of the disclosure includes processing, using a machine learning model (MLM), a representation of an image of at least a portion of a document to generate a plurality of pixel-level maps (PLMs), each PLMs of the plurality of PLMs characterizing associations of pixels of the image with a respective one of a plurality of object types. The MLM includes a backbone neural network (NN) processing the representation of the image and generating a feature tensor representative of the image. The MLM further includes a plurality of classification NNs, each classification NN of the plurality of classification NNs processing the feature tensor and generating one or more PLMs of the plurality of PLMs. At least a subset of the plurality of classification NNs is trained together with the backbone NN. The method further includes generating, using the plurality of PLMs, an object-level map identifying placement of one or more objects in the document.

In another implementation, a method of the disclosure includes identifying a size of a text depicted in an image of a document and representing, based at least on the identified size of the text, the image via a plurality of patches of a target size. The method further includes processing, using a machine learning model MLM, a first patch of the plurality of patches to generate a first plurality of pixel-level maps (PLMs), each PLMs of the first plurality of PLMs characterizing associations of pixels of the first patch with a respective object type of a plurality of object types. The method further includes processing, using the MLM, a second patch of the plurality of patches to generate a second plurality of PLMs, each PLMs of the second plurality of PLMs characterizing associations of pixels of the second patch with the respective object type of the plurality of object types. The method further includes generating, using at least the first plurality of PLMs and the second plurality of PLMs, an object-level map identifying location of one or more objects in the document.

In yet another implementation, a system of the disclosure includes a memory and a processing device communicatively coupled to the memory. The processing device is to process, using a machine learning model (MLM), a representation of an image of at least a portion of a document to generate a plurality of pixel-level maps (PLMs), each PLMs of the plurality of PLMs characterizing associations of pixels of the image with a respective one of a plurality of object types. The MLM includes a backbone neural network (NN) processing the representation of the image and generating a feature tensor representative of the image. The MLM further includes a plurality of classification NNs, each classification NN of the plurality of classification NNs processing the feature tensor and generating one or more PLMs of the plurality of PLMs. At least a subset of the plurality of classification NNs is trained together with the backbone NN. The processing device is further to generate, using the plurality of PLMs, an object-level map identifying placement of one or more objects in the document.

### BRIEF DESCRIPTION OF THE DRAWINGS

The disclosure will be understood more fully from the detailed description given below and from the accompanying drawings of various implementations of the disclosure. The drawings, however, should not be taken to limit the disclosure to the specific implementations, but are for explanation and understanding only.

FIG. 1 is a block diagram of an example computer system supporting operations of a neural network model capable of concurrent detection of objects of multiple types in documents, in accordance with some implementations of the present disclosure.

FIG. 2 illustrates example operations of preprocessing performed by a document processing engine that deploys one or more neural network models capable of concurrent detection of objects of multiple types, in accordance with some implementations of the present disclosure.

FIG. 3A illustrates an example rescaled document padded with left padding, bottom padding, right padding, and top padding, in accordance with some implementations of the present disclosure. FIG. 3B illustrates segmenting the padded document of FIG. 3A into multiple patches, in accordance with some implementations of the present disclosure.

FIG. 4 illustrates example operations of an object detection model (ODM) deployed as part of a document processing engine for concurrent detection of objects of multiple types, in accordance with some implementations of the present disclosure.

FIGS. 5A-5B illustrate example outputs of a PixelLink detection head, in accordance with some implementations of the present disclosure. FIG. 5A illustrates an output of classification heads of the ODM of FIG. 4 for an internal pixel A with eight neighbors depicted schematically with squares. FIG. 5B illustrates an output of classification heads of the ODM of FIG. 4 for pixel B that abuts pixel A.

FIGS. 6A-6B illustrate example portions of overlapping patches and aggregation of pixel probabilities, in accordance with some implementations of the present disclosure.

FIG. 7A illustrates an example input document processed by the ODM that operates in accordance with some implementations of the present disclosure. FIG. 7B shows a corresponding map of the document generated using the ODM, in accordance with some implementations of the present disclosure.

FIG. 8 is a flow diagram illustrating an example method of image preprocessing for concurrent detection of objects of multiple types in documents using neural networks, in accordance with some implementations of the present disclosure.

FIG. 9 is a flow diagram illustrating an example method of using neural networks for concurrent detection of objects of multiple types in documents, in accordance with some implementations of the present disclosure.

FIG. 10 depicts an example computer system that can perform any one or more of the methods described herein, in accordance with some implementations of the present disclosure.

### DETAILED DESCRIPTION

Operations of public, corporate, governmental, legal, commercial, and other entities require creating and processing billions of documents each day. Such documents have a large variety of types, contents, formats, sizes, etc., and can be prepared using a multitude of sources, languages, styles, and/or the like. Documents, e.g., forms, certificates, orders, receipts, invoices, etc., may include objects of various types, such as printed and/or handwritten words, tables, fields, checkboxes, signatures, seals, and/or the like. Many modern documents are created, used, modified, and stored in electronic forms, facilitated by the rise of powerful computing resources-including personal computing resources—that are becoming increasingly ubiquitous, deployed on desktop computers, smartphones, tablets, laptops and/or other similar devices. Development and spread of cloud computing services, big data centers serving businesses and public organizations, increased deployment of encryption, and other modern data exchange tools have led to the widespread use of electronic documents.

Electronic documents have advantages over printed documents in terms of cost, transmission and distribution capabilities, ease of editing and modification, as well as storage simplicity and reliability. Nonetheless, paper documents remain in use and circulation today and cannot be fully replaced with electronic documents in the foreseeable future. In many countries, specific types of documents—e.g., legislative documents, foundational business documents, documents regulating activities of organizations, certain types of contracts, etc.—are mandated to be in paper form. Inspecting documents and responding for requests to produce documents often requires printing electronic documents. Many documents, including historical documents, are stored on paper in printed, typed, and/or handwritten form and require transforming them into an electronic format.

An electronic document can include metadata that explicitly tracks types of objects and entries of the document, e.g., various printed and handwritten words, signatures, seals, checkboxes, and any other fields, and can further include values of those fields, e.g., specific typed words, presence or absence of a checkmark in a given checkbox, and so one. This makes extraction of relevant information from electronic documents relatively straightforward. Printed documents, on the other hand, are translated into electronic form as images. Before information can be extracted from such a document, objects contained in the document often need to be classified among specific types (e.g., printed text, handwritten text, table cell, etc.). Various computer vision algorithms can subsequently be applied to the objects separated by type, e.g., a printed text OCR algorithm can be applied to printed words, a handwritten text OCR can be applied to handwritten words, and/or the like. Modern OCR algorithms can efficiently operate on portable (camera-equipped) electronic devices, e.g., smartphones, and/or the like) and/or take advantage of cloud computing by uploading the documents for processing on cloud servers.

Completeness of detection and classification of various objects, speed of processing, and efficient use of available computational resources are important considerations in processing of images of documents. Existing techniques focus on algorithms that specialize on identification of objects of specific types, e.g., graphics, printed text, or handwritten text and are, therefore, less optimal for comprehensive document processing. As a result, when objects of multiple types need to be identified and analyzed, the same document may have to be processed multiple times, using different algorithms.

Aspects and implementations of the present disclosure address the above noted and other challenges of the existing document processing technology by providing for systems and techniques capable of fast and economical concurrent detection of objects of multiple types in documents. In some implementations, an incoming document may undergo pre-processing that includes identification of a font size (or a size of handwriting) S of a text of the document and rescaling (normalizing) the document to a target size/resolution S_{target} that matches the size of text that an object detection model (ODM) is trained to process, e.g., rescaling by a factor S_{target}/S, which may be greater or smaller than unity, depending on a document. In the instances where the dimensions of the rescaled document exceed a certain target size (e.g., length or width), the document can be cropped into patches of that target size and the patches can be independently processed by the ODM, e.g., sequentially or in parallel, if multiple instances of the ODM are available. In the instance where the dimensions of the rescaled document (or patches of the document) are below the target size, the document (or patches) can be padded to the target size.

The ODM can include a backbone network that encodes the input images (e.g., of a full document or multiple patches of the document) into a set of embeddings (also referred to as feature vectors and/or features herein). For example, an input image can have a dimension N×M (in pixels) where each pixel identified with coordinates x, y may be represented via a d-component feature F(x, y) that captures both a visual appearance of the pixel and the pixel's context (appearance of other pixels of the image). In some implementations, the backbone network may gradually reduce the dimension of the input image, e.g., using multiple convolutional kernels (filters) trained to capture an expanding field of view of the image, e.g., N×M=→n×m (such that the output features represent a new—smaller—set of n×m superpixels), while simultaneously increasing the number of dimensions, e.g., starting from three pixel color intensities and bringing the number up to the much larger number d. The set of combined features generated by the backbone network—also referred to as a feature tensor (of n×m×d dimensions)—may then be used as an input into multiple classification heads, each head performing a specific object identification task that the head is trained to do. In some implementations, each head includes a decoder network that decodes the n×m×d feature into a map N×M×{p}, where {p} represents a set of probabilities that a particular pixel of the input image (patch) belongs to various classes that the classification head is trained to identify. In one example, one head can be trained to determine a single probability p₁ that a pixel belongs to a portion of the image that includes a text, with 1−p₁ representing the probability that the pixel belongs to a non-textual portion of the image, e.g., a background portion, graphics, margins, etc. In another example, the head can output multiple probabilities, e.g., the probability p₁ of text/non-text classification and a set of probabilities p₂, p₃, p₄, etc., that the text is in English, Spanish, Chinese, etc. A second classification head may output a map of pixel-wise probabilities indicative of whether the pixels capture a region of a handwriting. A third classification head may similarly classify the pixels by the likelihood of belonging to a seal, a signature, and/or the like. A fourth classification head may identify associations of pixels with their neighbors, e.g., probabilities p₁, p₂, . . . p₈ that a pixel belongs to the same object as each of its eight closest neighbors. Various other classification heads may also be included in the ODM architecture (e.g., as may be useful for a particular domain-specific application) and trained using suitable training data. In some implementations, training of the backbone network and multiple classification heads may be performed together, end-to-end. In some implementations, after the backbone network and a set of initial classification heads have been trained (and even deployed), one or more additional classification heads may be trained using additional data to train the new head(s) (and, possibly, retrain the backbone network) in specific tasks to be learned by the new heads.

The advantages of the disclosed techniques include but are not limited to fast and resource-efficient detection of objects in documents. The objects may belong to a large variety of types that are detected simultaneously using an end-to-end machine learning model. Training of the model, including classification heads, can be performed using a single set of training documents featuring objects of various target types.

As used herein, a “document” may refer to any collection of symbols, such as words, letters, numbers, glyphs, punctuation marks, barcodes, pictures, logos, etc., that are printed, typed, handwritten, stamped, signed, drawn, painted, and the like, on a paper or any other physical or digital medium from which the symbols may be captured and/or stored in a digital image. A “document” may represent a financial document, a legal document, a government form, a shipping label, a purchasing order, an invoice, a credit application, a patent document, a contract, a bill of sale, a bill of lading, a receipt, an accounting document, a commercial or governmental report, or any other suitable document that may have any content of interest to some user. A “document” may include any region, portion, partition, table, table element, etc., that is typed, written, drawn, stamped, painted, copied, and the like. A “document” may be generated using any suitable computing application and may include any computer-readable file that encodes any collection of symbols represented (among other things) via drawing instructions, e.g., any collection of commands, prompts, guidelines and/or the like that, alone or in conjunction with any application, compiler, rendered, and/or the like, inform a computing device how a specific symbol is to be represented on a computer screen, a printed media (e.g., paper), or any other media from which the symbol can be perceived by a human or by another computer. Examples of documents that may include such drawing instructions include (but are not limited to) documents in the Portable Document Format (PDF), DjVu format, electronic publication format (EPUB), Printer Command Language (PCL) format, or any other similar format.

The techniques described herein may involve training one or more neural networks to process images, e.g., to classify inputs among any number of target classes of interest. The neural network(s) may be trained using training datasets that include various electronic documents or portions thereof. During training, neural network(s) may generate a training output for each training input. The training output of the neural network(s) may be compared to a desired target output as specified by the training data set, and the error may be propagated back to various layers of the neural network(s), whose parameters (e.g., the weights and biases of the neurons) may be adjusted accordingly (e.g., using a suitable loss function) to optimize prediction accuracy. Trained neural network(s) may be applied for efficient and reliable performance of any suitable classification tasks.

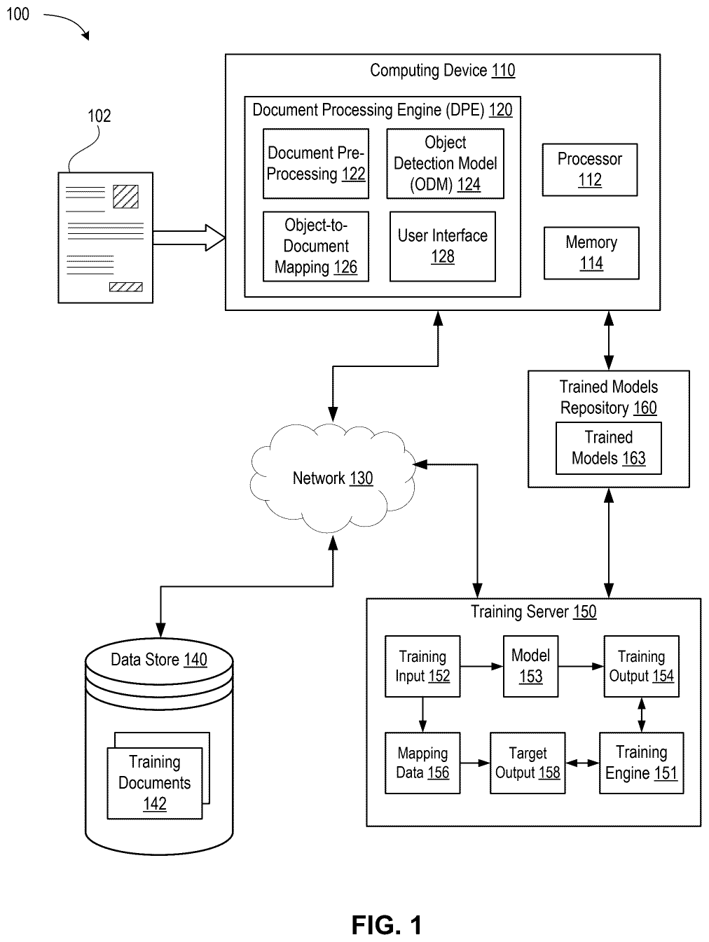

FIG. 1 is a block diagram of an example computer system 100 supporting operations of a neural network model capable of concurrent detection of objects of multiple types in documents, in accordance with some implementations of the present disclosure. As illustrated, computer system 100 may include a computing device 110, a data store 140, and a training server 150 connected via a network 130. Network 130 may be a public network (e.g., the Internet), a private network (e.g., a local area network (LAN), wide area network (WAN)), and/or a combination thereof.

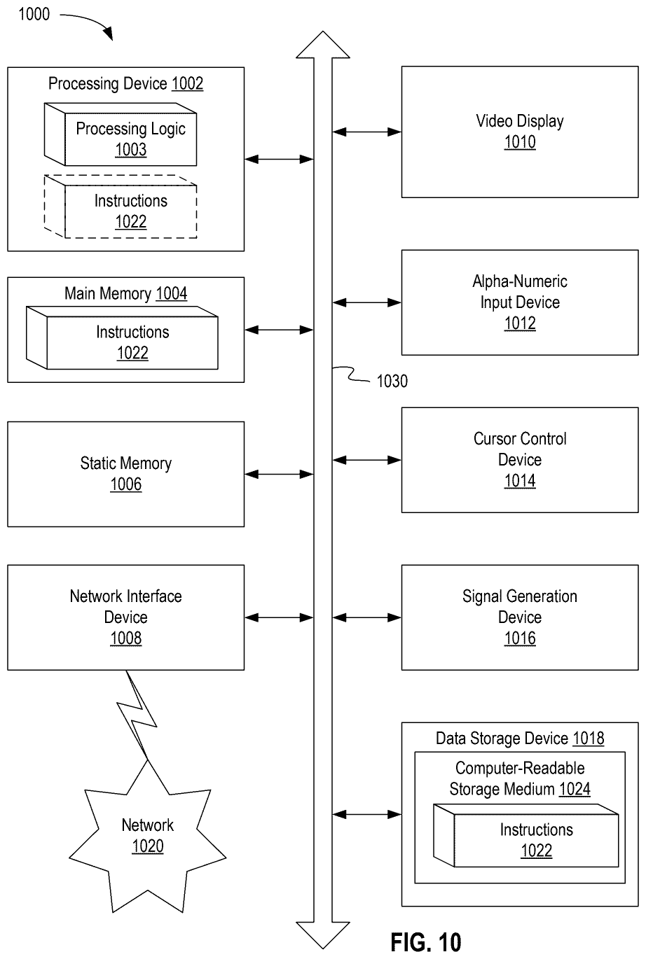

The computing device 110 may be a desktop computer, a laptop computer, a smartphone, a tablet computer, a server, a scanner, or any other suitable computing device capable of performing the techniques described herein. In some implementations, computing device 110 may be (and/or include) one or more computer systems 1000 of FIG. 10.

Computing device 110 may receive a document 102 that may include text(s), graphics, table(s), and/or the like. Document 102 may be received in any suitable manner, e.g., locally or over network 130, and may be a letter (printed or electronic), an invoice, a purchasing order, a shipping form, a bill of lading, a government form, a financial form, an accounting form, or any other type of document. In those instances where computing device 110 is a server, a client device (not shown) connected to the server via network 130 may upload a digital copy of document 102 to the server. In the instances where computing device 110 is a client device connected to a server via network 130, computing device 110 may download document 102 from the server or from data store 140.

Document processing engine (DPE) 120 may perform object detection and recognition for document 102, as described in the instant disclosure. In some implementations, DPE 120 may extract information from document 102 using multiple stages of processing. During the first stage, DPE 120 may perform document preprocessing 122, which may include enhancing (e.g., denoising, sharpening, etc.) document 102, normalizing document 102 (e.g., resizing, cropping into patches, etc.), converting document 102 from black-and-white (B&W) image to a color image, and/or the like. During a second stage, document 102 may be processed using an ODM 124 to identify locations of objects of various types in document 102. “Objects” may include printed text, handwritten text, graphics, tables, checkboxes, seals, stamps, signatures, logos, letterheads, and/or the like. The outputs of ODM 124 may be converted into an object-to-document mapping 126, which, in some implementations, may be presented on a suitable user interface 128, e.g., a monitor, display, screen, and/or the like, and/or stored in memory 114 of computing device 110, processed using various additional algorithms, e.g., OCR, communicated over network 130 (for storage and/or further processing), and/or used in any other applicable way.

Various components of DPE 120 may have access to instructions stored on one or more tangible, machine-readable storage media (e.g., memory 114) of computing device 110 and executable by one or more processors 112 of computing device 110. Processor(s) 112 may include one or more central processing units (CPUs), graphics processing units (GPUs), data processing units (DPUs), parallel processing units (PPUs), application-specific integrated circuits (ASICs), field-programmable gate arrays (FPGA), and/or any combination thereof. Processor(s) 112 supporting operations of DPE 120 may be communicatively coupled to one or more memory devices 114, including read-only memory (ROM), random access memory (RAM), flash memory, static memory, dynamic memory, and/or the like.

In some implementations, DPE 120 may be implemented as a client-based application or a combination of a client component and a server component. In some implementations, DPE 120 may be executed entirely on a client computing device, such as a desktop computer, a server computer, a tablet computer, a smart phone, a notebook computer, a camera, a video camera, or the like. Alternatively, some portion(s) of DPE 120 may be executed on the client computing device (which may receive document 102), e.g., document preprocessing 122, while other portion(s) of DPE 120, e.g., ODM 124 may be executed on a server device. The server portion may then communicate results of object detection to the client computing device, which may allow a user of the client computing device to perform various operations with document 102, such as performing OCR on document 102, parsing document 102, printing document 102, copying portions of document 102, and/or the like. Alternatively, the server portion may provide the results of object detection to another application. In other implementations, DPE 120 may execute on a server device as an Internet-enabled application accessible via a browser interface. The server device may be represented by one or more computer systems, such as one or more server machines, rackmount servers, workstations, mainframe machines, personal computers (PCs), and so on.

A training server 150 may construct one or more ODMs 124 to be deployed by DPE 120. Training server 150 may be and/or include a rackmount server, a router computer, a personal computer, a portable digital assistant, a mobile phone, a laptop computer, a tablet computer, a camera, a video camera, a netbook, a desktop computer, a media center, or any combination of the above. In some implementations, training may be performed by a training engine 151. In some implementations, training engine 151 may train models 153 that include neural networks having multiple neurons that perform classification tasks in accordance with various implementations of the present disclosure. Each neuron may receive its input from other neurons or from an external source and may produce an output by applying an activation function to the sum of weighted inputs and a trainable bias value. A neural network may include multiple neurons arranged in layers, including an input layer, one or more hidden layers, and an output layer. Neurons from different layers may be connected by weighted edges. In one illustrative example, all or some of the edge weights may be initially assigned random values.

Training of various models 153 may include using documents, for which ground truth object have been identified (e.g., by a human expert or user), as training inputs 152 into the models (e.g., ODMs 124) and changing parameters of the models in the direction that improves object detection by the models.

More specifically, training engine 151 may select one or more documents as training inputs 152 into a specific model 153 being trained and cause model 153 to generate a training output 154. Training engine 151 may compare training output 154 to a target (ground truth) output 158. Target output 158 may be mapped by mapping data 156 to the corresponding training inputs 152. In the instances of supervised training, mapping data 156 may include manual annotations of the documents of training inputs 152, e.g., human developer/user-identified objects. In the instances of unsupervised (or self-supervised) training performed using masked autoencoding techniques, mapping data 156 may include correct identification of masked areas of the training documents. During training, training engine 151 finds patterns in the correspondence of training inputs 152 to target outputs 158 and trains models 153 to capture such patterns.

The resulting error, e.g., a difference between the training output of a neural network (or some other machine-learning model 153) and the target output may be propagated back through one or more neural layers of model 153, and the weights and biases of model 153 may be adjusted in the way that makes training outputs closer to target outputs 158. This adjustment may be repeated until the error for a particular training input 152 satisfies a predetermined condition (e.g., falls below a predetermined error). Subsequently, a different training input 152 may be selected, a new training output 154 may be generated, and a new series of adjustments may be implemented, and so on, until the model is trained to a sufficient degree of accuracy or until the model reaches its limits predicated upon the model's architecture and sophistication.

Various models 153 (e.g., ODM 124) may include deep neural networks with one or more hidden layers, e.g., convolutional neural networks, recurrent neural networks (RNN), fully connected neural networks, neural networks with attention, transformer-based neural networks, or any combination thereof. The training data, including training inputs 152, target outputs 158, and mapping data 156, may be stored in data store 140. The patterns captured during training may be subsequently used by the models 153 (e.g., ODM 124) for future object identification (classification) during the inference phase. In some implementations, some of the models 153 may include a template-based classifier, a rule-based classifier, a feature-based classifier, and/or some other suitable type of classifier.

Data store 140 may be a persistent storage capable of storing files as well as data structures to perform text recognition in electronic documents, in accordance with implementations of the present disclosure. Data store 140 may be hosted by one or more storage devices, such as main memory, magnetic or optical storage disks, tapes, or hard drives, network-attached storage (NAS), storage area network (SAN), and so forth. Although depicted as separate from the computing device 110, data store 140 may be part of computing device 110. In some implementations, data store 140 may be a network-attached file server, while in other implementations, data store 140 may be some other type of persistent storage, such as an object-oriented database, a relational database, and so forth, that may be hosted by a server machine or one or more different machines coupled via network 130. In some implementations, data store 140 may store one or more training documents 142. In some implementations, at least some of the training documents 142 may be stored on computing device 110 or training server 150.

Once one or more models 153 have been trained, the resulting trained model(s) 163 may be stored in a trained models repository 160 (hosted by any suitable storage devices or a set of storage devices) and provided to DPE 120 of computing device 110 (and/or any other computing device) for inference analysis of new documents. For example, computing device 110 may process a new document 102 using ODM 124, identify objects of new document 102, and use the identified objects to perform target extraction of information from new document 102. The extracted information may be used in any applicable way, including but not limited to further information processing, storing, printing, copying, communicating, and so on.

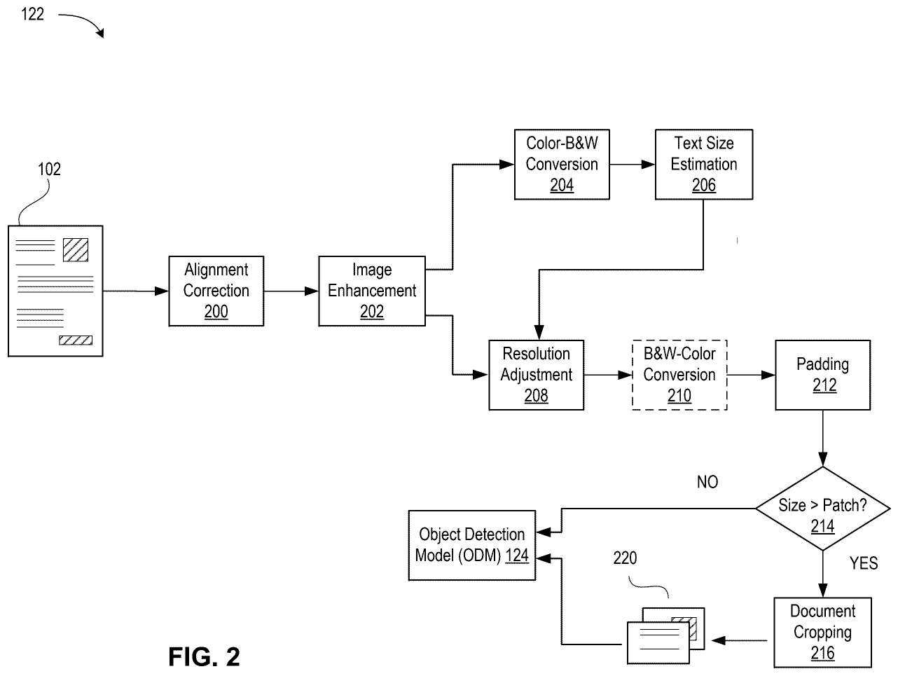

FIG. 2 illustrates example operations of preprocessing 122 performed by document processing engine 120 that deploys one or more neural network models capable of concurrent detection of objects of multiple types, in accordance with some implementations of the present disclosure. Operations of FIG. 2 may include receiving document 102. Document 102 may have text content, e.g., typed text, handwritten text, etc. Text content of document 102 may be in any suitable human-readable (or machine-readable) form, including any written language and/or any set of alphanumeric symbols (e.g., letters, numerals, punctuation marks, etc.), glyphs, and/or other elements that are used to communicate lexical meaning in a written form. Document 102 may also have non-textual content, e.g., images, illustrations, elements of graphics, etc. Document 102 may also have a mixed content, e.g., content that includes elements of text and graphics, e.g., seals, stamps, logos, watermarks, pictures of text, text that is artistically drawn, and/or the like. Document 102 may also include any special content, e.g., signatures, barcodes, checkboxes, dividing lines, complex background, e.g., as may be found on passports, identification cards, certificates, etc. Document 102 may be a single-page document or a multi-page document.

Documents 102 processed using operations disclosed in conjunction with FIG. 2 may be structured or unstructured. Structured documents 102 are characterized by fixed locations of various fields, such as commonly used in government forms, credit applications, standard-form purchasing orders, and/or the like. Unstructured documents 102 are characterized by a free form in which various fields, names, entities, etc., appear within the document. For example, an unstructured document may be a purchasing order written in a letter form in which a name of the buying entity, an amount of goods, and a price of goods are stated in locations that are not repeatable or predictable. Similar techniques may be used in the instances of documents 102 that are semi-structured, with some of the fields, names, and entities appearing in fixed locations (e.g., an address of the vendor stated in the top-left corner of the documents) while other fields, names, and entities appearing in arbitrary locations.

Preprocessing 122 may include performing an alignment correction 200 that checks orientation of document 102 and aligns document 102 (e.g., by rotating clockwise or counterclockwise to 90 degrees) in a direction expected by ODM 124, e.g., with the top of the document facing up, in one example implementation. In some implementations, alignment correction 200 can rotate document 102 to any necessary angle, in the instances where document 102 was tilted while being scanned or photographed. For example, alignment correction 200 can apply one or more directional filters to document 102 to identify a tilt angle that the direction of the lines of text in document 102 makes with the horizontal and then rotate document 102 to compensate for the tilt. In some implementations, alignment correction 200 may be performed locally e.g., to compensate locally for perspective distortions, e.g., rotating parts of document 102 to somewhat different angles (e.g., in the instances where the central portion of document 102 is oriented correctly while one or more edge portions are tilted up or down).

Preprocessing 122 may further include one or more image enhancement 202 operations. Image enhancement 202 may include denoising of document 102 (e.g., removing noise artifacts, including point artifacts, spot artifacts, line artifacts, and/or the like), deblurring document 102 (e.g., applying of one or more edge filters to sharpen contours of objects in document 102, and/or the like), adjusting brightness and/or contrast of document 102, and/or using any other suitable image enhancement techniques.

Preprocessing 122 may include color-to-B&W conversion 204 that maps multiple color intensities (e.g., Red I_{R}, Green I_{G}, Blue I_{B} intensities) of individual pixels to a single B&W intensity I: I_{R}, I_{G}, I_{B}→I. In some implementations, color-to-B&W conversion 204 may include binarization of the resulting B&W intensity I(x, y), e.g., with pixels having intensity in the range I∈[0, I_{MAX}/2] being replaced with black pixels I→0 and pixels having intensity in the range I∈(I_{MAX}/2, I_{MAX}] being replaced with white pixels I→I_{MAX}. In those instances where document 102 is a B&W document, color-to-B&W conversion 204 may not be performed.

The B&W intensity map I(x,y) may be used for text size estimation 206 that applies one or more filters, masks, and/or the like, to identify a size of text in document 102. In one example implementation, text size S may be the height of a font of a printed text (e.g., height of lowercase or uppercase letters of the printed text), a height of a handwriting (e.g., an average size of handwritten symbols) in document 102. In some implementations, text size S may be the smallest size of the text of document 102. In some implementations, text size S may be an average size of the text of document 102. In some implementations, text size S may be a weighted average size of the text of document 102 with various detected text sizes Sⱼ (e.g., corresponding to multiple fonts of typed text and/or strings of handwriting) weighted with relative occurrences of such sizes in document 102.

Based on the estimated text size S, preprocessing 122 may perform resolution adjustment 208. As indicated in FIG. 2, in some implementations, resolution adjustment 208 may be performed using the original (e.g., color) document 102 (suitably adjusted and enhanced) rather than on the B&W image obtained via color-to-B&W conversion 204, as described above. Resolution adjustment 208 may include rescaling document 102 to a target size S_{target} of the text. More specifically, resolution adjustment 208 may include rescaling document 102 by the factor R=S_{target}/S, e.g., increasing the size of document 102 (e.g., as measured in pixels) if R>1 or decreasing size of document 102 if R<1. In some implementations, resolution adjustment 208 (e.g., upscaling or downscaling) may include interpolating new pixel intensities from the rescaled intensities I(Rx, Ry), e.g., using linear interpolation, spline interpolation, and/or any other suitable interpolation techniques. In some example implementations, resolution adjustment 208 may bring text size S_{target} to 8-12 pixels with the overall resolution of 100-200 dots per inch (DPI) or pixels per inch (PPI).

In those instances, where document 102 is a B&W document, document 102 may undergo B&W-to-color conversion 210, which may include assigning some suitable values to I_{R}, I_{G}, and I_{B}, based on B&W intensity I, e.g., the same values that are equal (or proportional to/). Although FIG. 2 shows B&W-to-color conversion 210 to be performed after resolution adjustment 208, in other implementations, B&W-to-color conversion 210 may be performed before or concurrently with resolution adjustment 208.

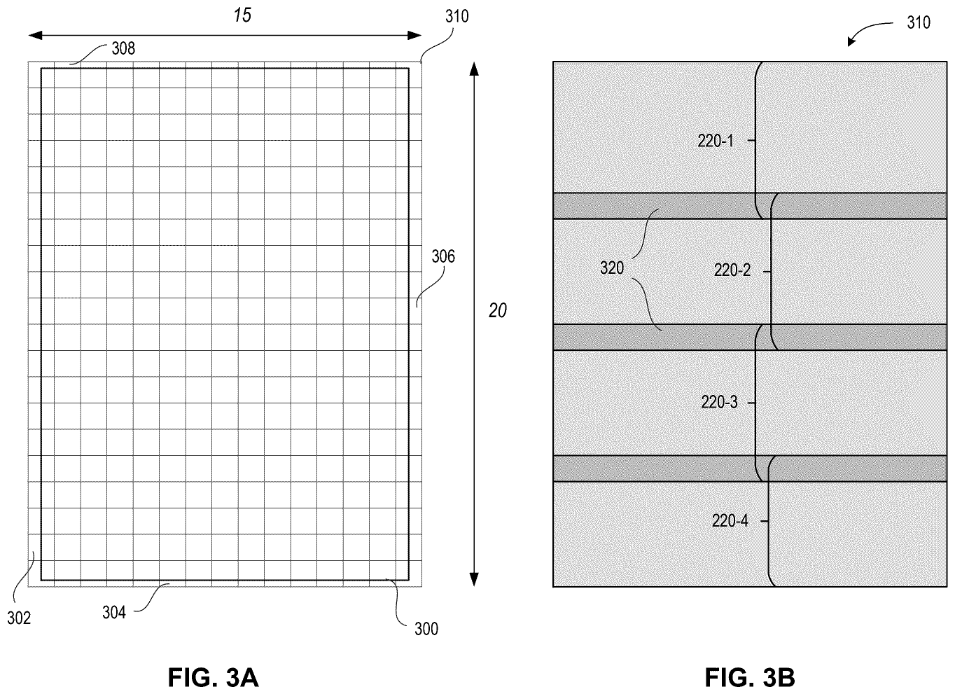

In some implementations, the rescaled document may undergo padding 212, e.g., to increase horizontal and/or vertical dimensions of the rescaled document to an integer number of tiles, e.g., square 128×128 pixel tiles, or tiles of some other suitable size. In other implementations, tiles may be of a rectangular shape with different lengths along the horizontal and the vertical dimensions. Padding 212 may include adding pixels of a uniform background intensity (e.g., white pixels, gray pixels, etc.) to the margins of the rescaled document (e.g., symmetrically at both edges of the document). FIG. 3A illustrates an example rescaled document 300 padded with left padding 302, bottom padding 304, right padding 306, and top padding 308, in accordance with some implementations of the present disclosure. For example, if the rescaled document 300 has the size of 1860×2510 pixels, a padded document 310 may be padded to the size of 1920×2560 pixels corresponding to 15×20 tiles (as illustrated in FIG. 3A). In this example, padding may include adding white stripes that are 30 pixels wide to each of the left and the right edges of the rescaled document (paddings 302 and 306) and similarly adding white stripes that are 25 pixels high to each of the bottom and top edges of the rescaled document (paddings 304 and 308).

Returning to FIG. 2, at block 214, the size of the (rescaled and padded) document may be compared to dimensions of a suitably selected (e.g., empirically) target patch, e.g., an a×b patch (in units of tiles). If the document fits within a single patch, the document can be forwarded to ODM 124 for processing. If the document exceeds the size of a single patch, the document can undergo document cropping 216 into multiple patches 220 of the target size and the patches 220 can be independently processed by ODM 124. In some implementations, patches 220 may be processed by ODM 124 sequentially, e.g., one after another. In some implementations, patches 220 may be processed in parallel, e.g., if multiple instances of ODM 124 are available. FIG. 3B illustrates segmenting padded document 310 of FIG. 3A into multiple patches 220-n, in accordance with some implementations of the present disclosure. As illustrated in FIG. 3B, patches 220-n may be overlapping by a certain amount. For example, patches 220-1, 220-2, and 220-3 are 15×6 tile patches and overlap over a vertical distance of one tile. Patch 220-4 is a catch-all patch capturing the remaining bottom portion of 15×5 tiles of padded document 300. Although FIG. 3B illustrates patches 220 that extend across the whole width of padded document 310, in other implementations, patches 220 may extend over a fraction of padded document 310. In some implementations, patches 220 may run across the whole width of padded document 310. In some implementations, the size of patches 220 may be dynamic, dependent on a layout of a specific document 102. For example, a given document 102 may first be analyzed and segmented into regions that have visual similarity, e.g., normal text region, small text region, graphics region, table region, and/or the like. Individual segmented regions may be developed into individual patches, e.g., using padding 212. Although rectangular patches 220 are illustrated in FIGS. 3A-3B, in some implementations, patches of any other shape may be used, e.g., trapezoid patches, triangular patches, honeycomb patches, and/or the like. In some implementations, the size (and/or the shape) of patches 220 may be determined by computational and memory resources available for execution of ODM 124, with smaller-sized patches used with lower-resources systems and larger-sized patches used with more resource-rich systems.

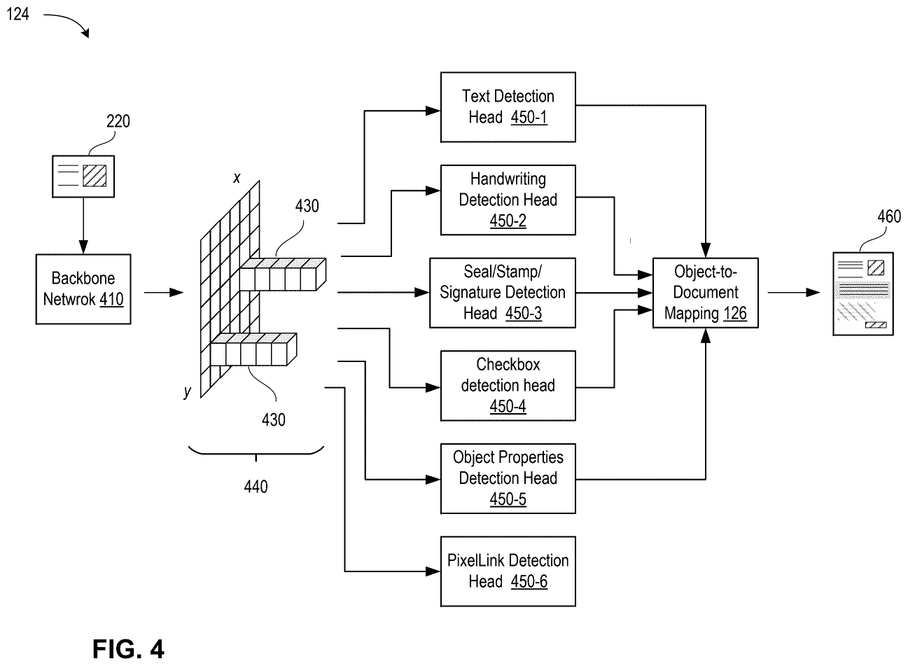

FIG. 4 illustrates example operations of an object detection model 124 deployed as part of document processing engine 120 for concurrent detection of objects of multiple types, in accordance with some implementations of the present disclosure. ODM 124 may process a patch 220 (e.g., obtained as disclosed in conjunction with FIG. 2 and FIGS. 3A-3B) using a backbone network 410. In some implementations, backbone network 410 applies a set of multiple kernels (filters) to the input patch 220 initially represented via an N×M×c object, where N is the number of pixels along the horizontal dimension of patch 220, M is the number of pixels along the vertical dimension of patch 220, and c is the number of channels, e.g., three for RGB pixels, four for CMYK pixels, and/or some other suitable number of channels. Backbone network 410 generates an output that includes a set of superpixels x, y, with individual superpixels associated with features 430. The number n×m of superpixels may be different (e.g., smaller) than the number N×M of pixels in the patch 220. In particular, various convolutional filters of backbone network 410 may gradually reduce the resolution of the patch N×M→n×m while simultaneously increasing the number of channels, c→C. In one illustrative non-limiting example, the resolution may be decreased from 150 PPI to 18 PPI, such that one superpixel represents approximately 70 pixels of patch 220 while the number of channels increases from c=3 channels per pixels to C=480 channels per superpixel. The increased number of channels ensures that a superpixel's feature F(x, y) 430 captures not only content and visual appearance of the pixels associated with superpixel x, y but also a much broader context that extends well beyond such pixels. The combined set of feature vectors 440 represents a feature tensor 440 that is used as an input into classification heads 450-n.

In some implementations, backbone network 410 may deploy depthwise separable convolutions instead of, or in addition to, convolution layers, e.g., similarly to MobileNetV1 architecture, in which convolutional operations are factorized by separating spatial filtering (e.g., using depthwise convolutions) from feature generation (e.g., using 1×1 pointwise convolutions). In some implementations, backbone network 410 may deploy a linear bottleneck and inverted residual architecture with blocks of 1×1 expansion convolutions followed by depthwise convolutions and 1×1 projections, with block inputs and outputs connected via residual (skipped) connections, e.g., similarly to MobileNetV2 architecture. In some implementations, backbone network 410 may deploy lightweight attention modules that use squeeze-and-excitation blocks introduced into a bottleneck structure, e.g., similarly to MnasNet and MobileNetV3 architectures. In some implementations, backbone network 410 may deploy a feature pyramid network (FPN) architecture in which features are generated at multiple input image resolutions and are then propagated from the lowest resolution to the highest resolution while features 430 being are generated.

As illustrated in FIG. 4, the n×m×C dimensional feature tensor 440 may be used as an input into a set of classification heads 450-n, each head performing a specific object identification function that the head is trained to accomplish. In some implementations, individual classification heads 450-n may include a decoder network that processes feature tensor 440 into a map N×M×{p}, where {p} represents a set of classification probabilities for a particular pixel (of the N×M pixels of the original patch 220) that the respective classification head is trained to determine.

In one example, the first classification head may be a text detection head 450-1 that is trained to determine a probability p_{T} for a pixel to belong to a portion of the image (e.g., patch 220) that includes a typed text, with the value 1−p_{T} representing the probability for the pixel to belong to a portion of the image that does not have a typed text, belong instead to background, graphics, margins, handwritten text, and/or the like. In some implementations, text detection head 450-1 may output more than one probability. For example, text detection head 450-1 may further output a probability p_{E} that the pixel is associated with an English character, a probability p_{S} that the pixel is associated with a Spanish character, a probability p_{C} that the pixel is associated with a Chinese character, and/or the like.

In another example, a second classification head may be a handwriting detection head 450-2 outputting a probability p_{H} for a pixel to belong to a handwritten portion of patch 220 (with the probability 1−p_{H} representing the probability that the pixel does not belong to any handwritten portion).

Other classification heads 450-n may perform various additional similar tasks of semantic segmentation. For example, seal/stamp/signature (SSS) detection head 450-3 may determine one or more probabilities that a given pixel belongs to a seal/stamp or a signature. In some implementations, a pixel may be classified as both a signature (by SSS detection head 450-3) and a typed text (by text detection head 450-1), e.g., when the signature is placed electronically, or as both a signature and a handwritten text (by handwriting detection head 450-2), e.g., when the signature was placed by hand.

Checkbox detection head 450-4 may output a probability pcs that a pixel is associated with a checkbox in patch 220. Additional probabilities outputted by checkbox detection head 450-4 may include a probability that the pixel belongs to a checkmark placed in (or in association with) the checkbox, one or more probabilities that the checkbox is of a certain form (e.g., square, rectangular, circular, and/or the like), and/or the like.

Object properties detection head 450-5 may output one or more probabilities that a pixel is associated with an object having one or more target features, e.g., a probability that the pixel belongs to an inverted text (e.g., a pixel of white text/handwriting on a dark background), a direction of reading of a portion of text associated with the pixel (e.g., left-to-right or right-to-left), and/or any other properties of objects that one may attempt to determine (and train object properties detection head 450-5 to detect).

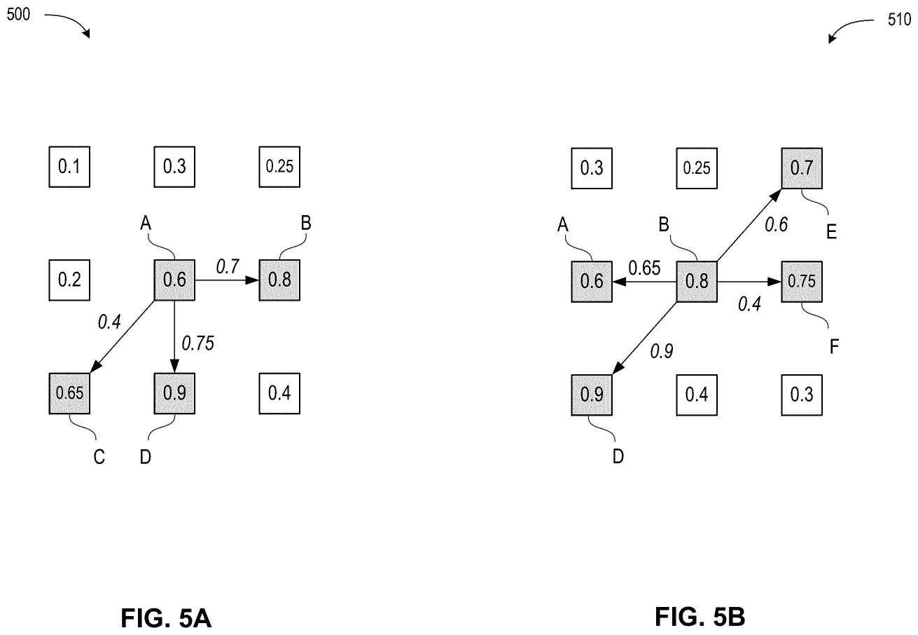

In some implementations, a PixelLink detection head 450-6 may be trained to predict, for individual pixels, probabilities of associations with other pixel neighbors. FIGS. 5A-5B illustrate example outputs of PixelLink detection head 450-6, in accordance with some implementations of the present disclosure. For a given pixel, PixelLink detection head 450-6 may output probabilities for various neighbors of the pixel, e.g., eight probabilities p₁, p₂, . . . p₈ for an internal pixel, five probabilities for an edge pixel, three probabilities for a corner pixel, and the like. FIG. 5A illustrates an output 500 of classification heads 450-n of ODM 124 of FIG. 4 for an internal pixel A with eight neighbors depicted schematically with squares. (Pixels are shown as spaced for the sake of convenience and ease of illustration.) Text detection head 450-1 (or handwriting detection head 450-2) may output probabilities—indicated with numbers inside the squares—that the corresponding pixels belong to a printed (or handwritten) text. Pixels that are unlikely (e.g., with lower than the 0.5 threshold probability) to be associated with text are illustrated with white squares and pixels that are likely (e.g., with higher than the 0.5 probability) to be associated with text are illustrated with shaded squares.

Text detection head 450-1 (or handwriting detection head 450-2) may have predicted 0.6 probability for pixel A, indicating that pixel A is likely a text pixel (typed or handwritten). Probabilities that pixel A is associated with various other pixels, as generated by PixelLink detection head 450-6, are indicated in FIG. 5A with the italicized numbers next to edges (arrows) connecting pixel A with the respective neighboring pixels. (For conciseness and ease of viewing, only PixelLink probabilities for shaded text pixels are shown in FIG. 5A.) For example, a PixelLink probability P_{AB} that pixel A is associated with pixel B is determined to be P_{AB}=0.7, indicating that pixel A and pixel B may belong to the same portion of text (e.g., word, letter/numeral, part of a letter/numeral, and/or the like).

In some implementations, decisions about associations of pairs of pixels may be made based on more than a single association probability. FIG. 5B illustrates an output 510 of classification heads 450-n of ODM 124 of FIG. 4 for pixel B that abuts pixel A. PixelLink detection head 450-6 may output a second probability P_{BA} that pixel B is associated with pixel A. For example, the probability that pixel B is associated with pixel A (as determined for pixel B) may be P_{BA}=0.65. A decision whether to associate pixel A and pixel B with the same connected text component may be made based on both probabilities P_{AB} and P_{BA}. In one implementation, the minimum of the two probabilities is compared to a set threshold probability P_{T} (e.g., P_{T}=0.5) and an association of the two pixels is formed provided that

min (P_{AB},P_{BA})>P_{T}.

In some implementations, the association is formed provided that the maximum of P_{AB} and P_{BA} exceeds the threshold. In some implementations, the association is formed provided that the average of P_{AB} and P_{BA} exceeds the threshold, e.g., the arithmetic average,

$$\frac{{P}_{AB} + {P}_{BA}}{2} > {P}_{T} .$$

although various other averages (e.g., geometric average, harmonic average, and/or the like) can be used in some implementations.

Classification heads 450-n described in conjunction with FIG. 4 and FIGS. 5A-5B should be understood as a way of illustration and not limitation as numerous other classification (detection) heads may be trained, e.g., barcode detection heads, QR-code detection heads, complex background (driver licenses, identification documents, passports, and/or the like) detection heads, separation lines detection heads, table elements detection heads, graphics detection heads, letterhead/logo detection heads, and/or the like. For example, a separation lines detection head may predict a binary mask of lines separating the document into multiple partitions or semantic regions, with pixels associated with separation lines identified using a first binary value (e.g., 1, 0, and/or the like) and pixels of the background given a second binary value (e.g., 0, 1, and/or the like). In some implementations, any or some of the functions described as supported by multiple classification heads 450-n may be performed by a single classification head. For example, any, some, or all functions of text detection head 450-1, handwriting detection head, 450-2, and/or checkbox detection head 450-5 may be implemented by a single detection head.

In some implementations, classification heads 450-n may have an architecture that includes one or more convolutional layers, such as layers with depthwise and pointwise convolutions, attention blocks (including self-attention and cross-attention blocks), transformer blocks, MobileNetV1/V2/V3 blocks, MnasNet blocks, FPN blocks, and/or the like, or some combination thereof. In one example, neural blocks of classification heads 450-n may increase resolution from the superpixel resolution (n×m pixels) to a higher resolution, e.g., the original resolution (N×M pixels) of patch 220 or a final resolution of N′×M′ pixels that is lower than the original resolution. At the same time, the number of channels may decrease from C to C′. In one illustrative example, the final resolution may correspond to 37.5 PPI, 75 PPI, and/or some other value and the number of channels may be C′=32, 64, or some other number of channels. Different classification heads 450-n may have different final resolutions N′×M′ and/or number of channels C′. For example, text detection head 450-1 may have the final resolution of 75 PPI while SSS detection head 450-2 may have a lower resolution of 57.5 PPI. The outputs of classification heads 450-n may be obtained by applying a final neuron classifier, e.g., a softmax classifier, a sigmoid classifier, etc., to the C′ channels of each of the N′×M′ pixels.

Processing of individual patches 220 may result in multiple detection outputs (probabilities) for those pixels that belong to overlapping regions 320 (with reference to FIG. 3B) since a pixel in an overlapping region may belong to two or more patches 220, depending on a specific way in which the input document is split into patches. For example, pixels located near a corner of a patch may simultaneously belong to four patches. In the instance of multiple classification results available for a given pixel, the classification results may be aggregated in a suitable way. For example, if N probabilities p; for the pixel are available, the pixel may be assigned the aggregated probability,

$${p}_{agg} = {\sum }_{j = 1}^{N} {w}_{j} \cdot {p}_{j} ,$$

where weight wⱼ is proportional to the distance from the pixel to an edge of patch 220-j whose processing generated the respective probability pⱼ. In some implementations, the aggregated probability may the maximum probability of the set of probabilities, P_{agg}=max {pⱼ}, or the minimum probability of the set of probabilities, P_{agg}=max {pⱼ}. In some implementations, outputs of individual classification heads 450-n may be aggregated independently.

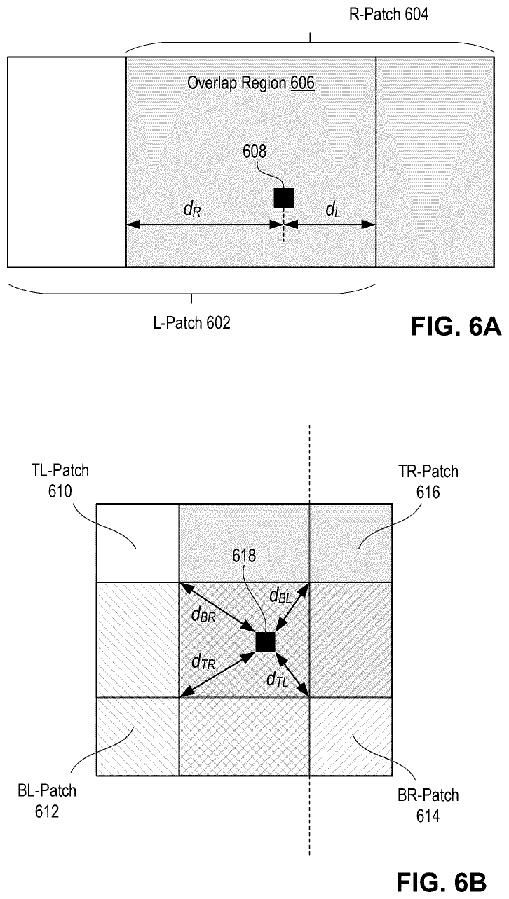

FIGS. 6A-6B illustrate example portions of overlapping patches and aggregation of pixel probabilities, in accordance with some implementations of the present disclosure. For example, FIG. 6A illustrates a left patch (L-Patch) 602 overlapping a right patch (R-Patch) 604. In one example implementation, probabilities p_{R} and p_{L} generated for pixel 608 located within an overlap region 606 may be aggregated according to

$${p}_{agg} = \frac{{d}_{L} \cdot {p}_{L} + {d}_{R} \cdot {p}_{R}}{{d}_{L} + {d}_{R}} ,$$

where d_{L} and d_{R} are distances from pixel 608 to the edges of left patch 602 and right patch 604, respectively. Correspondingly, outputs (probabilities) determined near an edge of a patch are assigned progressively smaller weights the closer a specific pixel is to an edge of that patch. Although weights in this example are linear functions of the distances d_{L} and d_{R}, in various other implementations any other suitable non-linear (including affine, polynomial, exponential, etc.) weight functions may be used.

FIG. 6B illustrates another example of a top-left patch (TL-Patch) 610 overlapping with a bottom-left patch (BL-Patch) 612, a bottom-right patch (BR-Patch) 614, and a top-right patch (TR-Patch) 616. In one example implementation, probabilities p_{TL}, p_{BL}, p_{BR}, and PTR generated for pixel 618 located within an overlapping region 606 may be aggregated according to

$${p}_{agg} = \frac{{d}_{TL} \cdot {p}_{TL} + {d}_{BL} \cdot {p}_{BL} + {d}_{BR} \cdot {p}_{BR} + {d}_{TR} \cdot {p}_{TR}}{{d}_{TL} + {d}_{BL} + {d}_{BR} + {d}_{TR}} ,$$

where d_{TL}, d_{BL}, d_{BR}, and d_{TR} are distances from pixel 618 to the corners of top-left patch 610, bottom-left patch 612, a bottom-right patch 614, and a top-right patch 616, respectively. Although weights in this example are linear functions that depend on the distances to the corners of the respective patches, in various other implementations any other suitable linear, affine, or a nonlinear function may be used, which may separately depend on the distances from pixel 618 to each of a side of a respective patch (and not just the distances to the corners).

Referring again to FIG. 4, the outputs of various classification heads 450-n may be provided to object-to-document mapping 126, which outputs a map of the document (MoD) 460. To create a comprehensive MoD 460, object-to-document mapping 126 may collect and combine object detections performed for each patch 220 of document 102 and assign obtained detections to various pixels and groups of pixels of the document. For example, object-to-document mapping 126 may access probabilities generated by PixelLink detection head 450-6 and identify clusters of connected pixels associated with specific objects, e.g., printed and/or handwritten words, signatures, seals, elements of graphics, checkboxes, and/or the like. The connected clusters can then be enclosed with bounding boxes, polygons, convex hulls, and/or other boundaries of target objects. The bounded objects may be processed in any suitable way, e.g., presented on a user interface (UI), subjected to OCR (e.g., in the instances of printed text/handwritten text/checkboxes/etc.), computer vision image processing (e.g., in the instances of identified images and/or graphical elements), and/or the like.

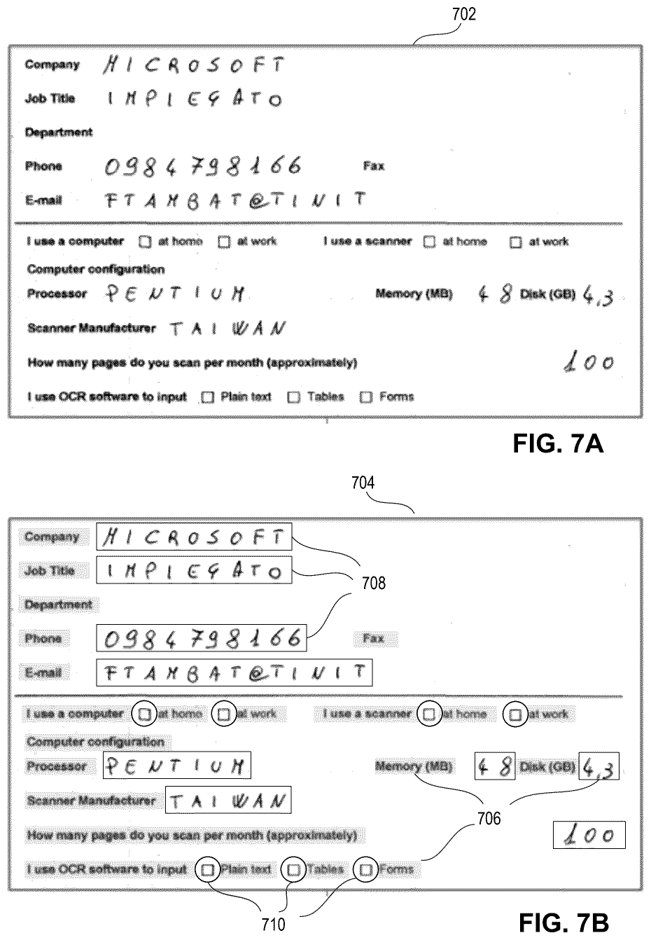

FIG. 7A illustrates an example input document 702 processed by ODM 124 that operates in accordance with some implementations of the present disclosure. FIG. 7B shows a corresponding map of document (MoD) 704 generated using ODM 124, in accordance with some implementations of the present disclosure. As illustrated, MoD 704 depicts, with shaded regions 706, areas of document 702 corresponding to the identified printed text. MoD 704 further depicts, with rectangular boxes 708, areas of document 702 corresponding to the identified handwritten text. MoD also depicts, with circles 710, areas of document 702 corresponding to the identified checkmarks.

In some implementations, training of the ODM 124 may be performed end-to-end, with backbone network 410 and classification heads 450-n trained together. In the end-to-end training, a training document may be processed by both the backbone network 410 and at least some of classification heads 450-n and an output of classification heads 450-n can be compared with ground truth, which may include the training document bearing correct identifications of target objects, e.g., printed and/or handwritten text, checkboxes, seals, stamps, signatures, and/or the like. The identifications of objects may be in the form of mark-ups placed by a human developer using any suitable user interface, pointing tool, input-capturing device (e.g., mouse, stylus, touchscreen, etc.), and/or the like. A mismatch (error) between the outputs of classification heads 450-n and the ground truth may be evaluated (quantified) using a suitable loss (cost) function and backpropagated through backbone network 410 and classification heads 450-n, changing learnable parameters (e.g., neural weights and biases in the direction that reduces the mismatch, e.g., using the steepest descent method or other techniques of machine learning. Loss functions used in training may include—in the way of example and not limitation-a binary cross entropy loss function (e.g., to evaluate correctness of binary pixel classification), a mean squared error loss function (e.g., to evaluate correctness of identified boundaries of various objects), and/or some other suitable loss function. In some implementations, backbone network 410 and classification heads 450-n may be trained with—in the way of example and not limitation—learning rates selected in the interval between 1×10⁻⁴ and 1×10⁻³, epoch count between 20 and 100, and training images sizes 896×648 pixels, 1792×1280 pixels, 1920×2560 pixels, and/or other suitable learning rates, epoch counts, image sizes, and various other training hyperparameters.

In some implementations, training of training of backbone network 410 and classification heads 450-n may be performed for multiple target text sizes S_{target}, e.g., text sizes within an interval of training text sizes [Sₘᵢₙ, Sₘₐₓ]. This teaches ODM 124 to operate reliably even in situations where text size estimation 206 and resolution adjustment 208 (with reference to FIG. 2) have identified the text size S of document 102 with some error and rescaled document 102 to a less than optimal resolution.

In some implementations, training of backbone network 410 and classification heads 450-n may include techniques of unsupervised learning. In one example, backbone network 410 may be pretrained using masked autoencoding techniques in which one or more portions of a training document are masked and backbone network 410—possibly with an additional temporary decoder network—are trained to identify the missing (masked) content of the training document. After backbone network 410 and the temporary decoder network are trained to identify such content with a target degree of accuracy (e.g., a number of errors not exceeding a certain target percentage), the temporary decoder network can be discarded and backbone network 410 may undergo further training together with one or more classification heads 450-n, e.g., as disclosed above.

In some implementations, after backbone network 410 and a set of initial classification heads 450-n have been trained, one or more additional classification heads 450-n may be trained using additional training data training the new heads (and, possibly, the backbone network) in specific tasks to be learned by the new heads. For example, initial training may be performed for text detection head 450-1 and checkbox detection head 450-3 while subsequent training may be performed for handwriting detection head 450-2. In some implementations, during such additional training, only parameters of the newly trained classification head(s) may be learned (changed) while parameter of backbone network 410 remain unchanged. In some implementations, parameters of both the newly trained classification head(s) and backbone network 410 may be changed.

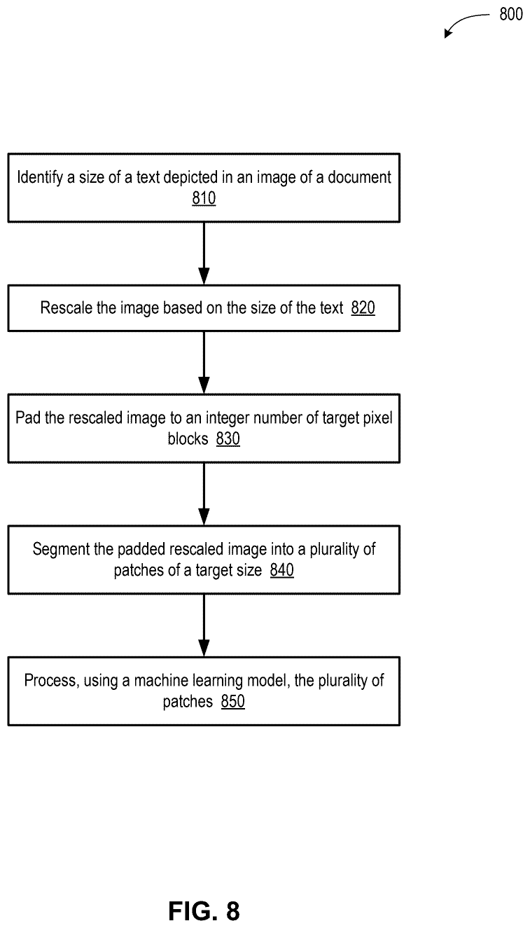

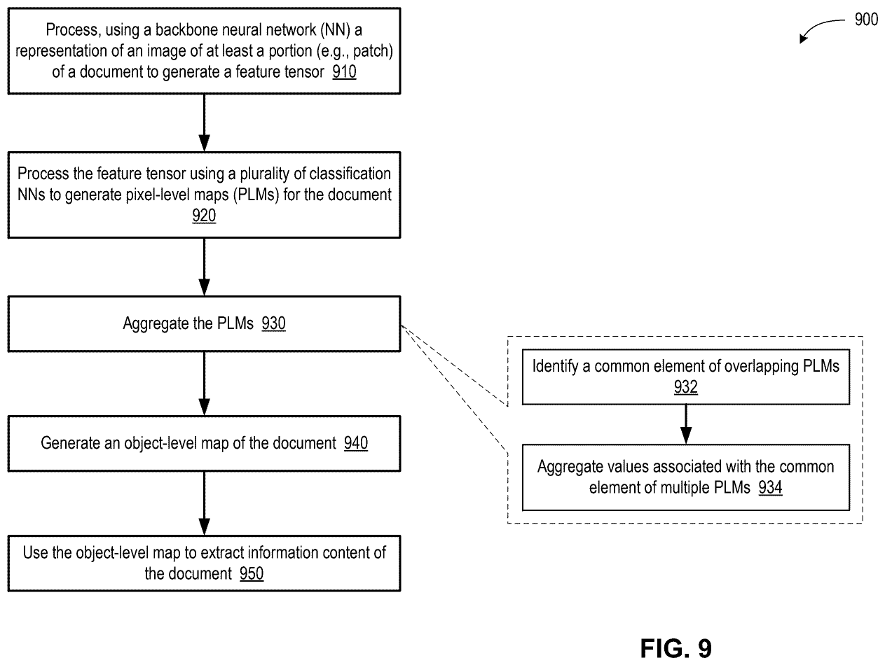

FIGS. 8-9 are flow diagrams illustrating example methods 800-900 of deploying neural network models for concurrent detection of objects of multiple types, in accordance with some implementations of the present disclosure. A computing device, having one or more processing units (e.g., CPUs, GPUs, PPUs, DPUs, etc.) and memory devices communicatively coupled to the processing units, may perform methods 800-900 and/or each of their individual functions, routines, subroutines, or operations. The processing device executing methods 800-900 may be processor 112 of computing device 110 in FIG. 1. In certain implementations, a single processing thread may perform any of methods 800-900. Alternatively, two or more processing threads may perform any of methods 800-900, each thread executing one or more individual functions, routines, subroutines, or operations of the methods. For example, multiple threads may execute separate instances of ODM 124 to process in parallel multiple patches 220 of document 102. In an illustrative example, the processing threads implementing any of methods 800-900 may be synchronized (e.g., using semaphores, critical sections, and/or other thread synchronization mechanisms). Alternatively, the processing threads implementing any of methods 800-900 may be executed asynchronously with respect to each other. Various operations of methods 800-900 may be performed in a different order compared with the order shown in FIGS. 8-9. Some operations of methods 800-900 may be performed concurrently with other operations. Some operations may be optional.

FIG. 8 is a flow diagram illustrating an example method 800 of image preprocessing for concurrent detection of objects of multiple types in documents using neural networks, in accordance with some implementations of the present disclosure. At block 810, method 800 may include identifying the size of a text depicted in an image of a document. Using the identified size of the text, a processing device implementing method 800 may represent the image via a plurality of patches of a target size. For example, at block 820, method 800 may include rescaling (e.g., by S_{target}/S) the image based on the identified size of the text (e.g., S) and a target size of the text (e.g., S_{target}). At block 830, method 800 may continue with padding the rescaled image to an integer number of target pixel blocks (e.g., 128×128 pixel blocks, 256×128 pixel blocks, and/or blocks of any other size). At block 840, method 800 may continue with segmenting the padded rescaled image into the plurality of patches of the target size. In some implementations, at least some of the patches may be overlapping.

At block 850, method 800 may continue with processing, using a machine learning model (MLM), the obtained plurality of patches (e.g., a first patch, a second patch, etc.) to generate a plurality of pixel-level maps (PLMs) for each patch. Individual PLMs may characterize associations of pixels of the patches with respective object types. The generated PLMs may be used to obtain an object-level map identifying locations of one or more objects in the document.

FIG. 9 is a flow diagram illustrating an example method 900 of using neural networks for concurrent detection of objects of multiple types in documents, in accordance with some implementations of the present disclosure. In some implementations, method 900 may be used to process images that have been preprocessed as disclosed in conjunction with method 800. In some implementations, method 900 may be used with images that have not been so preprocessed or whose preprocessing lacked any one or more operations of method 800. For example, an input image may have been segmented into patches, but not rescaled.

Method 900 may include processing, using a machine learning model (MLM), a representation of an image of at least a portion of a document to generate a plurality of pixel-level maps (PLMs). In some implementations, the portion of the document may be a specific patch of the document. In some implementations, the portion of the document may include the whole document, e.g., in the instances where the document size is less than a size of a patch or in instances where no segmentation into patches is performed. Individual PLMs of the plurality of PLMs may characterize associations of pixels of the image with a respective one of a plurality of object types. For example, the plurality of PLMs may include a PLM characterizing associations of pixels of the image with a printed text, a PLM characterizing associations of pixels of the image with a handwritten text, a PLM characterizing associations of pixels of the image with one or more special objects including at least one of a checkbox, a seal, or a stamp, and/or other PLMs.

In some implementations, processing the representation of the image may include operations illustrated in blocks 910 and 920. More specifically, at block 910, a backbone neural network (NN) may process the representation of the image to generate a feature tensor representative of the image. At block 920, a plurality of classification NNs may process the feature tensor. Each classification head may generate one or more PLMs. At least a subset of the plurality of classification NNs may be trained together with the backbone NN for at least a portion of training. In some implementations, the MLM may include a pixel-link classification NN that processes the feature tensor and generates a PLM characterizing likelihoods of neighboring pixels of the image belonging to a same-type object (e.g., as disclosed in conjunction with FIG. 5A-5B.)

Operations of blocks 910 and 920 may be repeated for each portion (patch) of the image, if applicable. In some implementations, each of the one or more additional images may partially overlap the image, or one or more of the other additional images of the document. In some implementations, the MLM (or another instance/copy of the MLM, if processing is performed in parallel), may process one or more additional images (e.g., patches) of the document to generate one or more additional pluralities of PLMs. For example, a second plurality of PLMs may be generated for a second patch, a third plurality of PLMs may be generated for a third patch, and so on.

In some implementations, e.g., where the document is segmented into multiple patches, method 900 may include aggregating, at block 930, the plurality of PLMs (e.g., generated for the first patch) with the one or more additional pluralities of PLMs (generated for the second, third, etc., patches) to obtain a plurality of aggregated PLMs. For example, an aggregated text detection PLM may be obtained by aggregating text detection PLMs of multiple patches.

In some implementations, aggregating the plurality of PLMs with the one or more additional pluralities of PLMs may be performed using operations illustrated in the callout portion of FIG. 9. More specifically, at block 932, method 900 may include identifying a common element (e.g., pixel 608 or pixel 618) of a first PLM of the plurality of PLMs (e.g., a PLM of the text probabilities for the first patch) and a second PLM of the one or more additional pluralities of PLMs (e.g., a PLM of the text probabilities for the second patch). At block 934, method 900 may include aggregating a first value associated with the common element of the first PLM (e.g., probability p_{L}, with reference to the description of FIG. 6A) and a second value associated with the common element of the second PLM (e.g., probability p_{R}, with reference to the description of FIG. 6A) to obtain an aggregated value (e.g., probability p_{agg}) associated with the common element of an aggregated PLM of the plurality of aggregated PLM.

In some implementations, aggregating the first value and the second value may include selecting a maximum value of the first value and the second value as the aggregated value. In some implementations, aggregating the first value and the second value may include selecting a minimum value of the first value and the second value as the aggregated value. In some implementations, aggregating the first value and the second value may include selecting a weighted combination of the first value and the second value as the aggregated value. Weights in the weighted combination may be determined based on a location of the common element within an overlapping portion of the first PLM and the second PLM, e.g., as illustrated in FIG. 6A and FIG. 6B and the corresponding descriptions.

In some implementations, method 900 may include, at block 940, generating an object-level map (e.g., as illustrated in FIG. 7B) that identifies placement of one or more objects in the document. In those implementations, where the document is segmented into multiple patches, operations of block 940 may include using the plurality of aggregated PLMs to generate the object-level map.

At block 950, method 900 may continue with using the object-level map to extract information content of the document. In one example, OCR may be applied to regions of the document that are identified to contain printed and/or handwritten text. In one example, a computer vision algorithm may be applied to regions of checkboxes to determine if checkboxes are empty or filled with checkmarks. In yet another example, images of the document may be cropped and processed using one or more object identification algorithms. For example, regions of barcodes can be processed using barcode recognition algorithms.

FIG. 10 depicts an example computer system 1000 that can perform any one or more of the methods described herein, in accordance with some implementations of the present disclosure. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a set-top box (STB), a Personal Digital Assistant (PDA), a mobile phone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The example computer system 1000 includes a processing device 1002, a main memory 1004 (e.g., read-only memory (ROM), flash memory, dynamic random-access memory (DRAM) such as synchronous DRAM (SDRAM)), a static memory 1006 (e.g., flash memory, static random access memory (SRAM)), and a data storage device 1018, which communicate with each other via a bus 1030.

Processing device 1002 (which can include processing logic 1003) represents one or more general-purpose processing devices such as a microprocessor, central processing unit, or the like. More particularly, the processing device 1002 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1002 may also be one or more special-purpose processing devices such as an application specific integrated circuit (ASIC), a field programmable gate array (FPGA), a digital signal processor (DSP), network processor, or the like. The processing device 1002 is configured to execute instructions 1022 for implementing various modules and components of DPE 120 of FIG. 1 and to perform the operations discussed herein, operations of method 800 of image preprocessing for concurrent detection of objects of multiple types in documents using neural networks and method 900 of using neural networks for concurrent detection of objects of multiple types in documents.

The computer system 1000 may further include a network interface device 1008. The computer system 1000 also may include a video display unit 1010 (e.g., a liquid crystal display (LCD) or a cathode ray tube (CRT)), an alphanumeric input device 1012 (e.g., a keyboard), a cursor control device 1014 (e.g., a mouse), and a signal generation device 1016 (e.g., a speaker). In one illustrative example, the video display unit 1010, the alphanumeric input device 1012, and the cursor control device 1014 may be combined into a single component or device (e.g., an LCD touch screen).

The data storage device 1018 may include a computer-readable storage medium 1024 on which is stored the instructions 1022 embodying any one or more of the methodologies or functions described herein. The instructions 1022 may also reside, completely or at least partially, within the main memory 1004 and/or within the processing device 1002 during execution thereof by the computer system 1000, the main memory 1004 and the processing device 1002 also constituting computer-readable media. In some implementations, the instructions 1022 may further be transmitted or received over a network 1020 via the network interface device 1008.

While the computer-readable storage medium 1024 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Although the operations of the methods herein are shown and described in a particular order, the order of the operations of each method may be altered so that certain operations may be performed in an inverse order or so that certain operations may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “analyzing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. Furthermore, the terms “first,” “second,” “third,” “fourth,” etc. as used herein are meant as labels to distinguish among different elements and may not necessarily have an ordinal meaning according to their numerical designation.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

What is claimed is:

1. A method comprising:
processing, using a machine learning model (MLM), a representation of an image of at least a portion of a document to generate a plurality of pixel-level maps (PLMs), each PLMs of the plurality of PLMs characterizing associations of pixels of the image with a respective one of a plurality of object types, wherein the MLM comprises:
a backbone neural network (NN) processing the representation of the image and generating a feature tensor representative of the image, and
a plurality of classification NNs, each classification NN of the plurality of classification NNs processing the feature tensor and generating one or more PLMs of the plurality of PLMs, wherein at least a subset of the plurality of classification NNs is trained together with the backbone NN; and
generating, using the plurality of PLMs, an object-level map identifying placement of one or more objects in the document.

2. The method of claim 1, further comprising:
processing, using the MLM, one or more additional images of the document to generate one or more additional pluralities of PLMs, each of the one or more additional images partially overlapping with at least one of:
the image, or
another additional image of the one or more additional images of the document; and
wherein generating the object-level map comprises using the one or more additional pluralities of PLMs.

3. The method of claim 2, wherein using the one or more additional pluralities of PLMs comprises:
aggregating the plurality of PLMs with the one or more additional pluralities of PLMs to obtain a plurality of aggregated PLMs; and
using the plurality of aggregated PLMs to generate the object-level map.

4. The method of claim 3, wherein aggregating the plurality of PLMs with the one or more additional pluralities of PLMs comprises:
identifying a common element of a first PLM of the plurality of PLMs and a second PLM of the one or more additional pluralities of PLMs; and
aggregating a first value associated with the common element of the first PLM and a second value associated with the common element of the second PLM to obtain an aggregated value associated with the common element of an aggregated PLM of the plurality of aggregated PLM.

5. The method of claim 4, wherein aggregating the first value and the second value comprises at least one of:
selecting a maximum value of the first value and the second value as the aggregated value;
selecting a minimum value of the first value and the second value as the aggregated value; or
selecting a weighted combination of the first value and the second value as the aggregated value, wherein weights in the weighted combination are determined based on a location of the common element within an overlapping portion of the first PLM and the second PLM.

6. The method of claim 1, wherein the plurality of PLMs comprises one or more of:
a PLM characterizing associations of pixels of the image with a printed text,
a PLM characterizing associations of pixels of the image with a handwritten text, or
a PLM characterizing associations of pixels of the image with one or more special objects comprising at least one of a checkbox, a seal, or a stamp.

7. The method of claim 1, wherein the MLM further comprises:
a pixel-link classification NN processing the feature tensor and generating a PLM characterizing likelihoods of neighboring pixels of the image belonging to a same-type object.

8. The method of claim 1, further comprising:
performing one or more preprocessing operations to obtain the representation of the image, the one or more preprocessing operations comprising:
identifying a size of a text depicted in the image; and
rescaling the image using the identified size of the text.

9. The method of claim 8, wherein the one or more preprocessing operations further comprise:
segmenting the rescaled image into a plurality of portions of a target size, each portion of the plurality of portions processed independently by the MLM.

10. The method of claim 9, wherein one or more of the plurality of portions are padded to the target size.

11. The method of claim 9, wherein at least two or more of the plurality of portions are overlapping.

12. A method comprising:
identifying a size of a text depicted in an image of a document;
representing, based at least on the identified size of the text, the image via a plurality of patches of a target size;
processing, using a machine learning model MLM, a first patch of the plurality of patches to generate a first plurality of pixel-level maps (PLMs), each PLMs of the first plurality of PLMs characterizing associations of pixels of the first patch with a respective object type of a plurality of object types;
processing, using the MLM, a second patch of the plurality of patches to generate a second plurality of PLMs, each PLMs of the second plurality of PLMs characterizing associations of pixels of the second patch with the respective object type of the plurality of object types; and
generating, using at least the first plurality of PLMs and the second plurality of PLMs, an object-level map identifying location of one or more objects in the document.

13. The method of claim 12, wherein the first patch and the second patch are overlapping.

14. The method of claim 12, wherein representing the image via the plurality of patches of the target size comprises:
rescaling the image, based on the identified size of the text and a target size of the text;
padding the rescaled image to an integer number of target pixel blocks; and
segmenting the padded rescaled image into the plurality of patches of a target size.

15. The method of claim 12, wherein generating the object-level map comprises:
aggregating the first plurality of PLMs and the second plurality of PLMs to obtain a plurality of aggregated PLMs; and
using the plurality of aggregated PLMs to generate the object-level map.

16. The method of claim 15, wherein aggregating the first plurality of PLMs and the second plurality of PLMs comprises:
identifying a first value associated with a common element in a first PLM of the first plurality of PLMs and a second value associated with the common element in a second PLM of the second plurality of PLMs; and
aggregating the first value and the second value to obtain an aggregated value associated with the common element of an aggregated PLM of the plurality of aggregated PLM.

17. The method of claim 16, wherein aggregating the first value and the second value comprises at least one of:
selecting a maximum value of the first value and the second value as the aggregated value;
selecting a minimum value of the first value and the second value as the aggregated value; or
selecting a weighted combination of the first value and the second value as the aggregated value, wherein weights in the weighted combination are determined based on a location of the common element within an overlapping portion of the first PLM and the second PLM.

18. The method of claim 12, wherein the first plurality of PLMs comprises one or more of:
a PLM characterizing associations of pixels of the image with a printed text,
a PLM characterizing associations of pixels of the image with a handwritten text, or
a PLM characterizing associations of pixels of the image with one or more special objects comprising at least one of a checkbox, a seal, or a stamp.

19. The method of claim 12, further comprising:
processing, using the MLM, the first patch to generate a pixel-link PLM characterizing likelihoods of neighboring pixels of the first patch belonging to a same-type object.

20. A system comprising:
a memory; and
a processing device communicatively coupled to the memory, the processing device to:
process, using a machine learning model (MLM), a representation of an image of at least a portion of a document to generate a plurality of pixel-level maps (PLMs), each PLMs of the plurality of PLMs characterizing associations of pixels of the image with a respective one of a plurality of object types, wherein the MLM comprises:
a backbone neural network (NN) processing the representation of the image and generating a feature tensor representative of the image, and
a plurality of classification NNs, each classification NN of the plurality of classification NNs processing the feature tensor and generating one or more PLMs of the plurality of PLMs, wherein at least a subset of the plurality of classification NNs is trained together with the backbone NN; and
generate, using the plurality of PLMs, an object-level map identifying placement of one or more objects in the document.
